(19) United States
(12) Patent Application Publication
(10) Pub. No.: US 2013/0218058 A1
(43) Pub. Date: Aug. 22, 2013

(54) APPARATUS FOR TRANSMITTING LOCALISED VIBRATIONS, IN PARTICULAR TO MUSCLES OF A USER

(71) Applicants: Fabrizio Ceoldo, Roma (IT); Fulvio Ceoldo, Roma (IT); Leonardo Ceoldo, Roma (IT)

(72) Inventors: Fabrizio Ceoldo, Roma (IT); Fulvio Ceoldo, Roma (IT); Leonardo Ceoldo, Roma (IT)

(73) Assignee: BOSCO SYSTEM LAB S.P.A., Roma (IT)

(21) Appl. No.: 13/881,603

(22) PCT Filed: Oct. 24, 2011
(86) PCT No.: PCT/IT11/00358

§ 371 Date: May 3, 2013

(30) Foreign Application Priority Data
Oct. 29, 2010 (IT) RM2010A000570

(51) Int. Cl. A61H 23/00

(52) U.S. Cl. CPC A61H 23/00
USPC 601/46

(57) ABSTRACT

The present invention concerns an apparatus for transmitting localised vibrations, in particular to muscles of a user, comprising a handpiece, vibrating means being coupled to said at least one handpiece, the apparatus being characterised in that the handpiece is coupled through connecting means to an applicator capable to be applied to an area of the body of the user said vibrating means being connected to a processing and controlling device that is housed in a control panel and in turn connected to interface means for inputting data capable to set a vibration frequency of said vibrating means.

The present invention relates to an apparatus for transmitting localised vibrations, in particular to muscles of a user, allowing a user, in a simple, effective, reliable, safe, comfortable, and inexpensive way, to undergo a mechanical neuromuscular stimulation produced through mechanical vibrations transmitted in a localised way, for a therapeutic/rehabilitative and/or athletic enhancement purpose, drastically reducing the involvement of body parts which have not to be stressed, for which the mechanical vibrations could be also harmful.

It is known that when a muscle is stimulated through application of mechanical vibrations, it contracts in a reflex way very similar to what occurs when the muscle is caused to work through voluntary contractions, e.g. during execution of physical exercises.

In particular, by modifying the mechanical vibration frequency, it is possible to selectively cause more or less rigid muscles to work.

Recently, many equipments for physical exercise having (at least) one vibrating element, usually activated by an electric motor, have been manufactured, which are capable to exert, through mechanical vibrations, a mechanical muscular stimulation; such equipments substantially comprise footboards for the leg muscles, and vibrating handles for the arm muscles.

Such equipments are useful for training, since they permit to obtain in a shorter time results similar to those of the usual physical exercises in a gym, for getting a good muscle tone with few minutes of application, and for physiotherapical uses aimed at maintenance of the muscle tone or at the functional recovery of the muscles, e.g. during or after periods of immobilisation two to fractures or surgery.

However, present equipments with vibrating elements have some drawbacks.

First of all, their use is inadvisable to elderly subjects, or subjects who have had recent trauma (or surgery, in particular orthopaedic surgery).

Moreover, a further drawback rises from the fact that the limbs, when subjected to mechanical vibrating stimulation, of any subject have a different rigidity, also called “stiffness”, and, consequently, they tend to differently oppose to the same (in amplitude and oscillation) vibration that is applied to the vibrating elements with which the same limbs interact. This entails that the assembly formed by the vibrating elements and interacting limbs will react in a different way to the vibrations generated by the motor depending on which limbs interact with the vibrating elements. By way of example, when both lower limbs are resting on a same vibrating footboard, the latter will move according to accelerations which are not exactly the ones corresponding to each one of the two different limbs, whereby the neuromuscular stimulation has not the maximum possible efficacy and, in some extreme cases (in particular when the stiffness of the two limbs is very different, as it occurs for instance after a period of immobilisation of one of the two limbs), it may also be harmful. Similar considerations are valid for the two upper limbs with a pair of vibrating handles.

Also, the neuromuscular stimulation may be applied only to the, either lower or upper, limbs, hindering a localised neuromuscular stimulation only limited to the muscle that actually needs such stimulation, implying the involvement of body parts which have not to be stressed and for which the mechanical vibrations could be also harmful

In this context, the solution proposed according to the present invention is introduced.

It is an object of this invention, therefore, to allow a user in a simple, effective, reliable, safe, comfortable, and inexpensive way, to undergo a neuromuscular stimulation through localised vibrations, drastically reducing the involvement of body parts which have not to be stressed, for which the mechanical vibrations could be also harmful

It is specific subject-matter of the present invention an apparatus for transmitting localised vibrations, in particular to muscles of a user, comprising a handpiece, vibrating means being coupled to said at least one handpiece, the apparatus being characterised in that the handpiece is coupled through connecting means to an applicator capable to be applied to an area of the body of the user, said vibrating means being connected to a processing and controlling device that is housed in a control panel and in turn connected to interface means for inputting data capable to set a vibration frequency of said vibrating means.

Always according to the invention, the handpiece may be removably coupled to the applicator, the apparatus preferably comprising a set of interchangeable applicators attachable to the handpiece, said applicators having more preferably a lower surface capable to contact an area of the body of the user and having a shape selected from the group comprising concave shapes, a flat shape, convex shapes, and flat shapes provided with one or more projections, preferably hemispherical projections.

Still according to the invention, said connecting means may comprise a plate, to which the handpiece is coupled, provided on a lower surface with one or more, preferably at least three, more preferably four, notches in each one of which a respective magnet is present, the applicator having an upper surface provided with one or more projecting elements, preferably screws, made of ferromagnetic material, preferably iron, said one or more projecting elements being capable to insert in said one or more notches, whereby the magnets are capable to attract said one or more projecting elements within said one or more notches.

Furthermore according to the invention, said connecting means may comprise a ring nut, integrally coupled to the handpiece or to the applicator, whereby the handpiece is orientatable with respect to the applicator according to an angle, preferably selected from a set of predetermined angles, more preferably equal to 0°, 20°, 60°, 90°, 120°, 150°, and 180° both clockwise and counterclockwise, said connecting means being preferably provided with indications related to the angle of reciprocal orientation between handpiece and applicator.

Always according to the invention, the apparatus may be provided with at least one pressure sensor capable to detect at least one pressure exerted by the applicator on the area of the body of the user to which it is applied and to send detection data to said processing and controlling device, said interface means comprising one or more visual and/or acoustic signaling devices through which said processing and controlling device signals at least one condition of application of the applicator on the area of the body of the user depending on said at least one pressure detected by said at least one pressure sensor, said at least one pressure sensor being preferably located on a lower surface of the applicator capable to contact the area of the body of the user, said processing and controlling device signaling more preferably an application condition wherein said at least one detected pressure is lower than at least one minimum value, said processing and controlling device still more preferably disabling an operation of said vibrating means when said at least one detected pressure is lower than at least one minimum value.

Still according to the invention, the apparatus may be provided with a, preferably elastic, belt coupled to the handpiece and fastenable around a body segment of the user in correspondence with the area of the body of the user to which the applicator is applied, the belt being preferably insertable into at least two slots of said connecting means, the belt being preferably fastenable through a buckle, the apparatus preferably comprising a set of interchangeable belts.

Furthermore according to the invention, said at least one pressure sensor may be located on an area of the belt capable to be positioned in contact with a body segment of the user.

Always according to the invention, the belt may be insertable into at least two slots of the plate, preferably so that the belt is capable to pass under the lower surface of the plate.

Still according to the invention, said at least one pressure sensor may be arranged on an area of the plate onto which the belt is capable to exert a pressure when it is fastened around a body segment of the user, preferably in the lower surface of the plate in a gap between the applicator and the lower surface of the plate.

Furthermore according to the invention, said at least one handpiece may comprise first sensing means capable to detect a frequency of vibration of said at least one handpiece and to send detection data to said processing and controlling device, said processing and controlling device controlling an operation of said vibrating means so that the vibration frequency detected by said first sensing means is equal to a vibration frequency set through said interface means.

Always according to the invention, said vibrating means may comprise at least one electric motor, that is housed in a respective seat with which said at least one handpiece is provided, capable to make a shaft rotate, preferably arranged along a longitudinal axis of said at least one handpiece, to which shaft one or more eccentric masses are integrally coupled, said at least one handpiece preferably further comprising a fan capable to cause an air exchange between said seat of said at least one electric motor and the outside of said at least one handpiece, said at least one electric motor being preferably capable to generate an undulating movement at a frequency preferably ranging from 1 to 1000 Hz, more preferably from 5 to 500 Hz, still more preferably from 20 to 55 Hz, and of amplitude preferably ranging from 1 to 10 mm, more preferably from 2 to 5 mm, said at least one electric motor being preferably capable to rotate both clockwise and counterclockwise and said interface means for data input being capable to set at least one direction of rotation of said at least one electric motor.

Still according to the invention, said first sensing means may comprise an encoder capable to detect an angular position and/or a rotation speed and/or a rotation frequency of the shaft.

Furthermore according to the invention, the apparatus may further comprise a detection system comprising movement sensing means capable to detect a movement of said at least one handpiece, said movement sensing means preferably comprising at least one triaxial accelerometer incorporated into or integrally coupled to said at least one handpiece, said movement sensing means being connected to said processing and controlling device to which it sends detected data related to one or more movement parameters preferably selected from the group comprising movement amplitude, acceleration, and velocity, said processing and controlling device preferably automatically controlling said vibrating means on the basis of said data detected by said movement sensing means.

Always according to the invention, the apparatus may further comprise vibration sensing means preferably comprising at least one triaxial accelerometer incorporated into or coupled to at least one support applicable to and/or wearable by a user, said at least one support being preferably selected from the group comprising an elastic collar and an elastic band, said vibration sensing means being connected to a said processing and controlling device to which it sends detected data related to one or more movement parameters preferably selected from the group comprising vibration amplitude, frequency, acceleration, and velocity, said processing and controlling device preferably automatically controlling said vibrating means on the basis of said data detected by said vibration sensing means.

Still according to the invention, the apparatus may further comprise a system for determining an optimal frequency of a vibration generated by said vibrating means and for automatically setting parameters of operation of said vibrating means, comprising one or more muscular electrical activity sensors, preferably electromyography sensors, applicable to one or more muscles of a user, capable to send detection data to said processing and controlling electronic device, said processing and controlling electronic device processing the data received from said one or more sensors so as to determine, within a range included between a lower limit frequency, preferably equal to 1 Hz, more preferably variable, and an upper limit frequency, preferably equal to 1000 Hz, more preferably variable, an optimal frequency of the vibration generated by said vibrating means at which the electrical activity of said one or more muscles of the user is maximum, said processing and controlling electronic device setting a frequency of the vibration generated by said vibrating means so that it is equal to such optimal frequency.

The apparatus for transmitting localised vibrations according to the invention permits to be used in complete safety also by subjects very sensitive to mechanical vibrations, such as elderly subjects, and/or suffering from osteoporosis, and/or who have had recent trauma (or orthopaedic surgery). In particular, the apparatus according to the invention may be used by subjects under rehabilitation and hence for physiotherapical use, where it is necessary a particularly calibrated use.

Furthermore, the apparatus for transmitting localised vibrations according to the invention is capable to take account of the different stiffness, in particular neuromuscular stiffness, of each specific neuromuscular structure of a particular user, that generates a different reaction of each specific neuromuscular structure to the vibrations generated by the motor. In fact, the apparatus according to the invention permits to assess the different muscle stiffness of the user, monitoring the different acceleration to which each vibrating element is subjected, so as to permit a different neurostimulation of each specific neuromuscular structure deriving from the different acceleration induced by its particular stiffness, allowing to obtain a high efficacy for each single neuromuscular structure (and for each single muscle) of each specific user. This causes the neuromuscular stimulation exerted by the apparatus according to the invention to be extremely effective.

Moreover, the possibility of orientating the vibrating motor enables to even spatially adapt the neuromuscular stimulation, maintaining over time the efficacy of the same stimulation.

Since the apparatus according to the invention may be provided with an either automatic or manual control of the motor operation, through the flexible possibility of combinations of amplitude, frequency, and acceleration over all the axes, it is adapted to any subject, with very soft and pleasant vibrations for elderly and neophyte subjects, indispensable during the first steps of rehabilitation from accidents or after surgery, for elongation and decompression, and also with powerful vibrations for enhancing use of strength.

In this regard, the apparatus has numerous advantageous applications. By way of example, and not by way of limitation, it may be used in the context of strategies aimed at particular geriatric pathologies, such as in case of osteoporosis, and in all those plans, whether these are rehabilitation ones or not, directed to improvement of the quality of life, intended in terms of degree of articular, muscle and neuromuscular function of the geriatric subject under consideration. Also, the apparatus according to the invention may be advantageously used in the field of sports training, most of all when the latter is aimed at increasing the levels of explosive strength, being as a matter of fact an optimal alternative and/or supplementary technique with respect to the classical strength training. Furthermore, the apparatus according to the invention may be still advantageously used as an integral part of all programs wherein the maximum limb muscle extensibility is desired, as well as in work plans aimed at chronic painful pathologies which may benefit from an increase of the muscular-tendinous compliance.

The present invention will be now described by way of illustration, not by way of limitation, according to its preferred embodiments, by particularly referring to the Figures of the annexed drawings, in which:

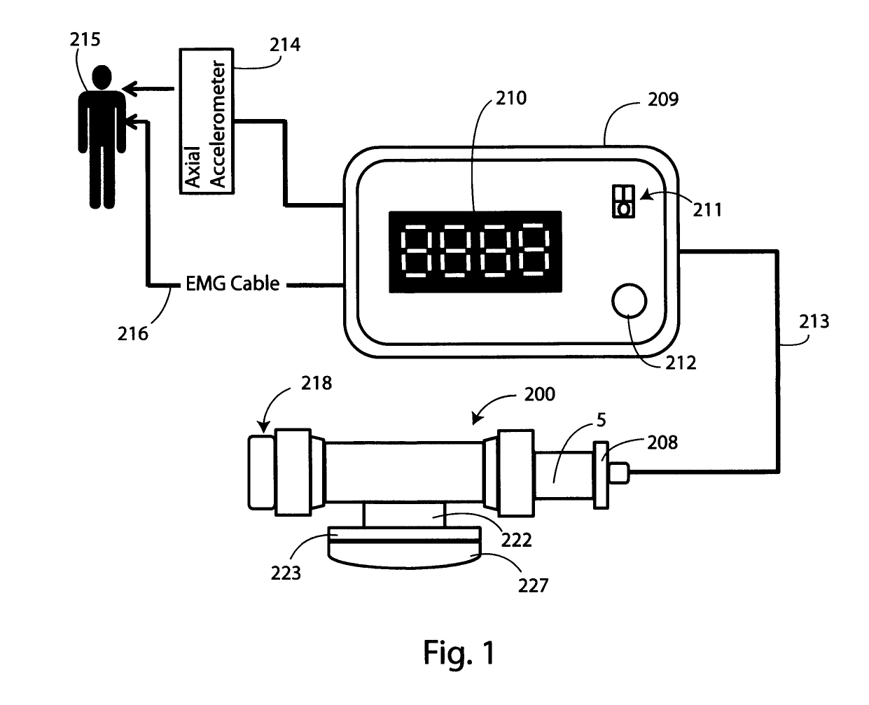

FIG. 1 shows a schematic view of the first embodiment of the apparatus according to the invention;

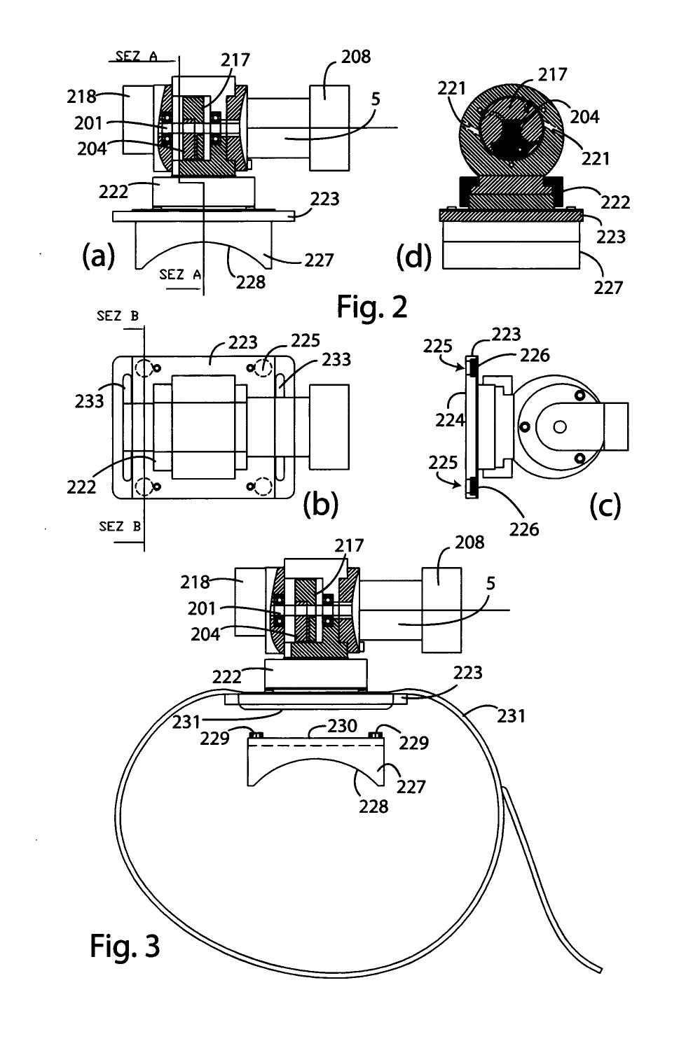

FIG. 2 shows a side view partially in section (FIG. 2a), a top plan view (FIG. 2b), a front view (FIG. 2c) and a cross-section view along line A-A of FIG. 2a (FIG. 2d) of a first portion of the apparatus of FIG. 1;

FIG. 3 shows a side view partially in section of a second portion of the apparatus of FIG. 1;

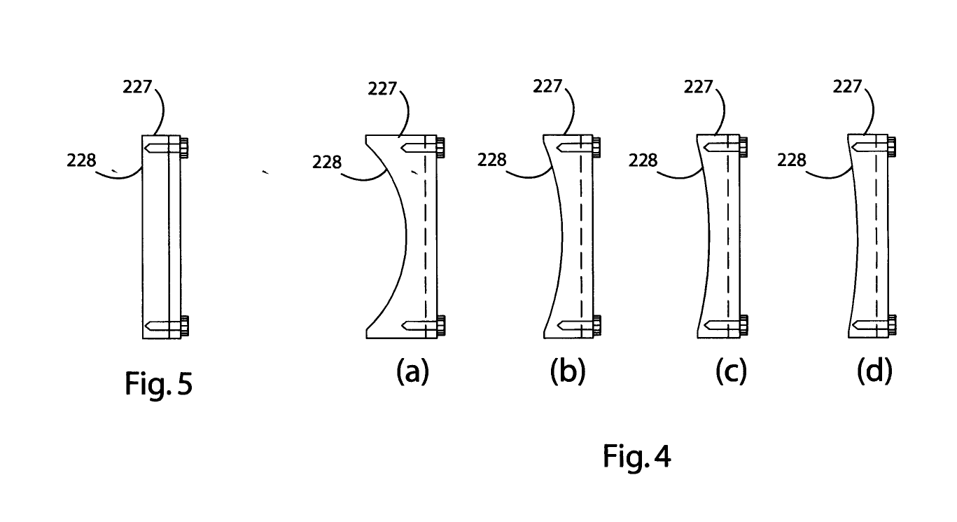

FIG. 4 shows a side view of four applicators with concave lower surfaces belonging to the set of interchangeable applicators of the apparatus of FIG. 1;

FIG. 5 shows a side view of an applicator with flat lower surface belonging to the set of interchangeable applicators of the apparatus of FIG. 1;

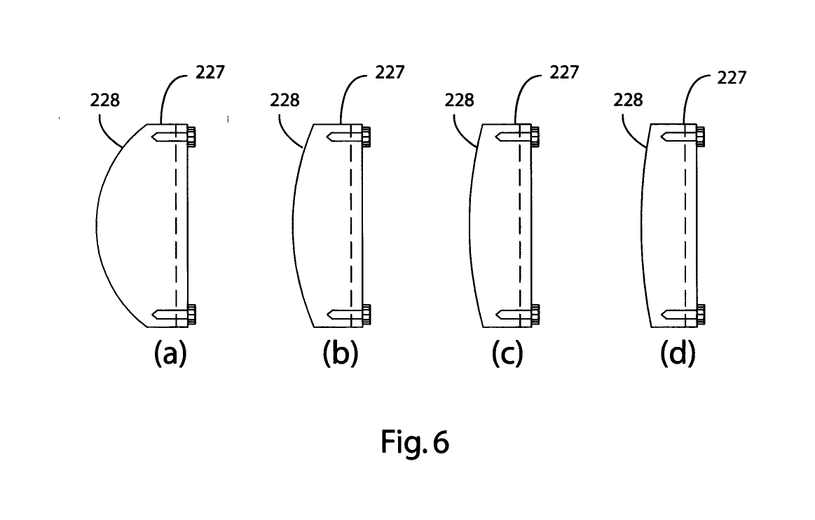

FIG. 6 shows a side view of four applicators with convex lower surfaces belonging to the set of interchangeable applicators of the apparatus of FIG. 1;

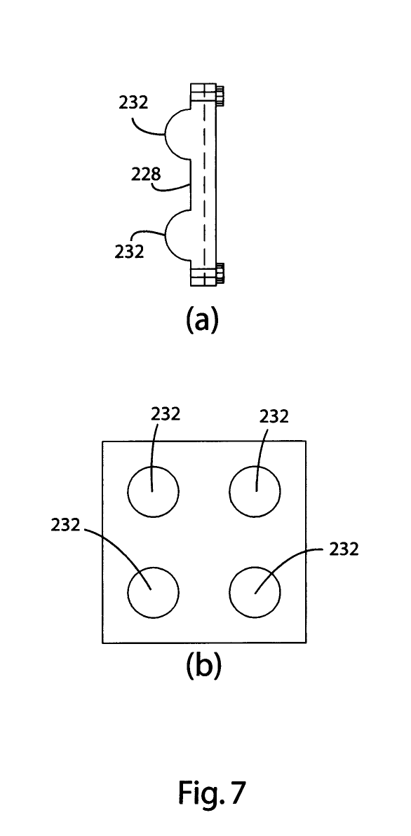

FIG. 7 shows a side view (FIG. 7a) and a bottom plan view (FIG. 7b) of an applicator with lower surface provided with projections belonging to the set of interchangeable applicators of the apparatus of FIG. 1;

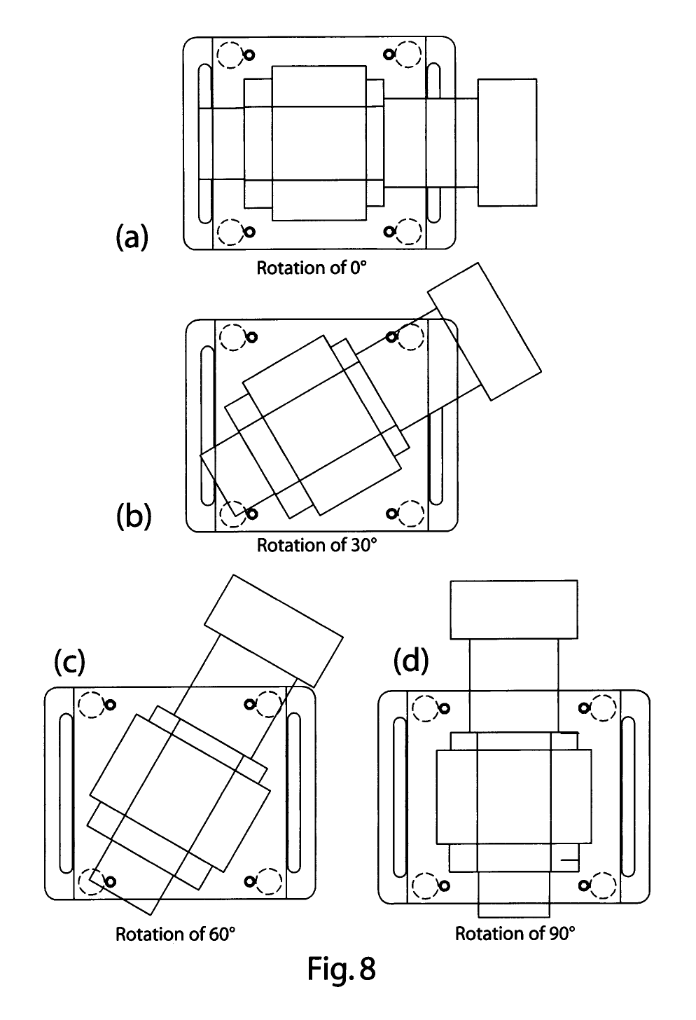

FIG. 8 shows a top plan view of the assembly handpiece-base plate of the apparatus of FIG. 1 in four orientations according to an angle equal to 0° (FIG. 8a), equal to 30° (FIG. 8b), equal to 60° (FIG. 8c);

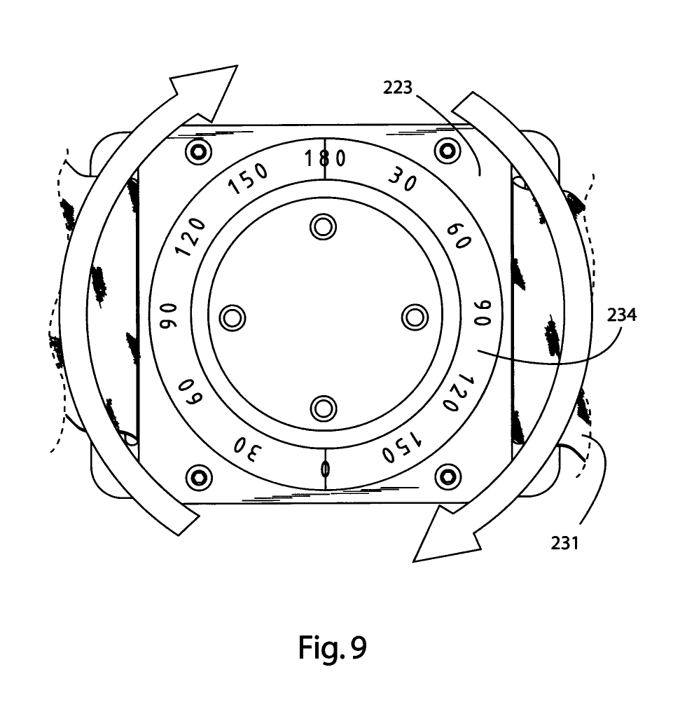

FIG. 9 shows a top plan view of a third portion of the apparatus of FIG. 1; and

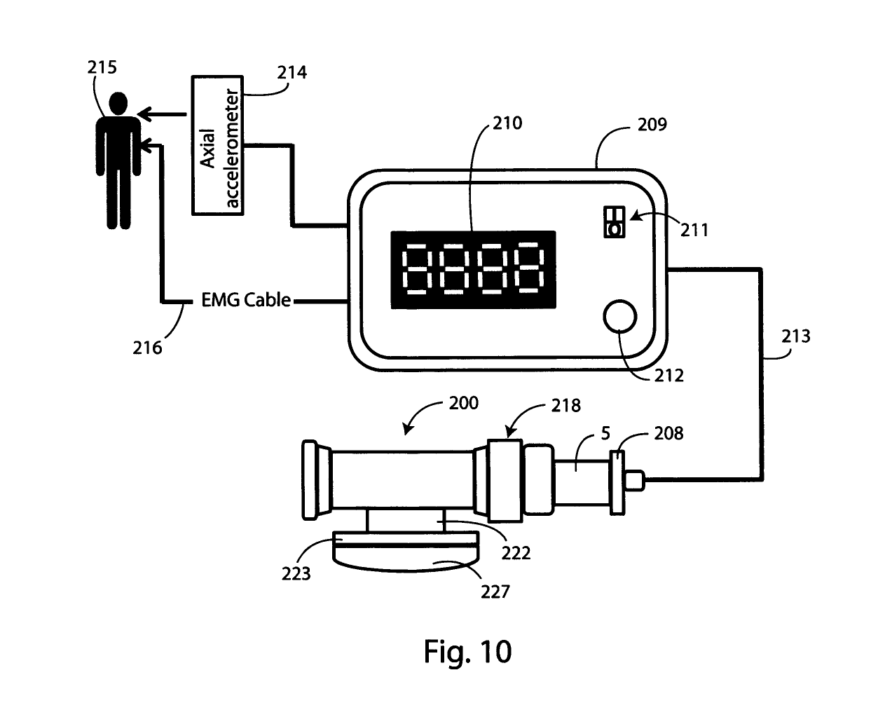

FIG. 10 shows a schematic view of a second embodiment of the apparatus according to the invention.

In the following description, the same reference numerals will be used to designate the same elements in the Figures.

In particular, dimensions shown in the Figures are by way of example and have not to be intended as limiting the scope of protection of the present invention, unless expressly indicated to the contrary.

With reference to FIGS. 1-3, it may be observed that a first embodiment of the apparatus for transmitting localised vibrations according to the invention comprises a handpiece 200 at an end of which an electric motor 5 is coupled, that is housed in a respective seat closed by a removable cover 208 (or other conventional attaching means). A fan 217, located in proximity of the motor 5, provide for cooling the latter, thanks to proper apertures 221 allowing hot air produced by the motor 5 to flow from the inside of the respective housing seat towards the outside.

The motor 5 is capable to make a shaft 201 to rotate, which shaft is arranged along the longitudinal axis of the handpiece 200, to which eccentric masses 204 are integrally coupled.

Other embodiments of the apparatus according to the invention may provide that the handpiece comprises more than one vibrating motor (or two or more other vibrating means), preferably two or more electric motors with eccentric masses.

The handpiece 200 is integrally coupled to a locking ring nut 222 in turn coupled to a base plate 223. In particular, by means of the ring nut 222, the handpiece 200 is orientatable with respect to the plate 223. The base plate 223 is provided on the lower surface 224 (that is planar) with four notches 225 (preferably located at the vertices of the plate 223 that is substantially a square) in which respective magnets 226 are present. An applicator 227, having concave lower surface 228, is capable to be removably magnetically coupled to the plate 223 by means of four screws 229, preferably made of iron (or other ferromagnetic materials capable to be attracted by the magnets 226), present on the upper surface 230 (that is planar) of the applicator 227, which have size corresponding and are arranged in positions corresponding to those of the four notches 225 of the lower surface 224 of the base plate 223; in fact, the magnets 226 are capable to attract the screws 229 within the four notches 225, which prevent the applicator 227 and plate 223 from mutually sliding anyhow, and to steadily maintain the coupling of the plate 223 to the applicator 227, preferably made of plastic material, more preferably of polyvinyl chloride (PVC).

When the electric motor 5 rotates the shaft 201, this puts in rotation the eccentric masses 204 within the handpiece 200, transmitting vibrations to the same handpiece 200 and from this to the plate 223 and to the applicator 227. The motor 5 generates an undulating movement at a frequency preferably ranging from 1 to 1000 Hz, more preferably from 5 to 500 Hz, still more preferably from 20 to 55 Hz, and of amplitude preferably ranging from 1 to 10 mm, more preferably from 2 to 5 mm. Moreover, the motor 5 may rotate both clockwise and counterclockwise.

In order to enable the transmission of vibrations to a muscle (or to another body part) of a user, the applicator 227 is blocked in position of contact with .such muscle through the use of a, preferably elastic, belt 231 that is inserted into two side slots 233 of the plate 223, so as to pass under the lower surface 224 of the latter, and that is fastened around a body segment (e.g. a limb or the chest) of the user in correspondence with the muscle to treat through a buckle (not shown). In this regard, the apparatus according to the invention preferably comprises a set of belts of different lengths, tensile capacities and widths, in order to enable a better attachment of the assembly handpiece 200-applicator 227 to each specific body segment and, consequently, an always efficient transmission of vibrations to the specific body part to treat. The use of the belt 231 allows the apparatus to be used without any need, for the user (or for a supervising operator, such as, for instance, a physiotherapist), of maintaining the applicator 227 in position of contact with the area to treat, preventing needless or even harmful vibrations to be delivered.

Similarly, the apparatus according to the invention preferably comprises a set of interchangeable applicators 227 magnetically attachable to the plate 223 and having different shapes of the lower surface 228, in order to enable a better transmission of vibrations to different body parts and/or to different patients. By way of example and not by way of limitation, FIGS. 4-7 show the applicators which are part of the set of interchangeable applicators with which the preferred embodiment of the apparatus according to the invention is provided. FIG. 4 shows four applicators 227 having concave lower surface 228 (with increasing radius from FIG. 4a to FIG. 4d), particularly suitable for treating fusiform muscles having different shape and size, whereby, upon variation of the fusiform shape, the radius of curvature of the concave lower surface 228 of the applicator to use varies; in particular, the applicators 227 of FIG. 4 enable conveyance of a significant neuromuscular stimulation in areas of medium/large size. FIG. 5 shows an applicator 227 having flat lower surface 228, particularly suitable for treating body areas having a low degree of curvature or where there is the need of stimulating an area of large size. FIG. 6 shows four applicators 227 having convex lower surface 228. (with increasing radius from FIG. 6a to FIG. 6d), particularly suitable for deeply transmitting the vibration in areas of medium/small size; in particular, the applicators 227 of FIG. 6 enable conveyance of a neuromuscular stimulation down to a level of a single tendon. FIG. 7 shows an applicator 227 having a flat lower surface 228 provided with four hemispherical projections 232, particularly suitable for deeply transmitting the vibration in areas of very small size.

The use of a magnetic-type attachment with the plate 223 renders the operations of replacement of the applicators 227 simple and rapid. However, it should be noted that the attachment between plate 223 and applicator 227 may be also of different type, such as for instance of mechanical type (e.g. through clamps), and could be also not removable, still remaining within the scope of the present invention.

Still making reference to FIG. 1, it may be observed that the motor 5 of the handpiece 200 is connected through a wired connection 213 to a control panel 209 provided with a processing device connected to a display 210, to a keypad (not shown) for data input, to an on/off button 211, and to a button 212 for turning the motor 5 off in case of emergency. Alternatively, the connection between motor 5 and control panel 209 may be also wireless, e.g. in the case where the power necessary to the operation of the motor 5 is provided through a battery housed in the same handpiece 200 or through an alternative connection to a mains supply. The keypad of the control panel 209 may be also integrated into the display 210, that in this case is of touch screen type. The control panel 209 enables a user to set and control the operation of the motor 5. In particular, when the motor 5 rotates, either clockwise or counterclockwise, it causes the handpiece 200 to make a specific undulating-vibrating movement concordant with the direction of rotation of the motor 5. Therefore, in the case where the direction of rotation of the motor 5 is selectable through the control panel 209, the two different directions of rotation of the same motor permit to generate two different neuromuscular stimulations.

The user (or a supervising operator, such as, for instance, a physiotherapist) may set on the control panel 209 the direction of rotation of the motor 5, as well as its frequency. In other embodiments of the apparatus for physical exercise according to the invention it is possible to set through the control panel 209 also the vibration amplitude, e.g. by automatically selecting the number and/or the weight of the eccentric masses 204 which are removably coupled to the shaft 201.

The handpiece 200 is provided with a system for detecting the vibration frequency of the handpiece 200, that in the preferred embodiment shown in the Figures comprises a sensor for sensing the rotation speed of the shaft 201. Such a system enables to precisely control that the handpiece 200 actually vibrates at the vibration frequency set on the control panel 209. In fact, wear over time of the vibrating means, comprising in the embodiment shown in FIGS. 1 and 2 the motor 5, the shaft 201 and the eccentric masses 204, causes a consequent modification of the mechanical strengths that as a matter of fact varies the actual vibration frequency (in particular, the wear of the eccentric masses 204 causes a variation of the rotation speed of the same eccentric masses 204). Still making reference to FIGS. 1-3, in the preferred embodiment, such system for detecting the rotation speed of the motor 5 comprises an encoder 218 applied to the shaft 201 that sends the detected data, related to the angular position and/or rotation speed and/or rotation frequency of the shaft 201, to the processing device of the control panel 209. The processing device of the control panel 209 processes the data received from the encoder 218 and consequently adjusts the rotation speed of the motor 5 so that the vibration frequency of the handpiece 200 is equal to the vibration frequency set on the control panel 209. Alternatively to or in combination with the encoder 218, the system for detecting the vibration frequency of the handpiece 200 may comprise further sensors, such as sensors for sensing angular movement.

The preferred embodiment of the apparatus according to the invention further comprises a pressure sensor (not shown), capable to (either directly or indirectly) sense the pressure exerted by the applicator 227 on the user's body area to treat, which sensor is connected to the processing device housed in the control panel 209 to which it sends the detected data. To this end, the pressure sensor may be located, by way of example and not by way of limitation:
on an area of the plate 223 on which the belt 231 exerts a pressure when it is fastened around the user's body segment (which pressure is substantially equal to the one exerted by the applicator 227 on the user's body area to treat); for instance on the lower surface 224 of the plate 223, provided that, when the applicator 227 is coupled to the plate 223, there is a gap between the upper surface 230 of the former and the lower surface 224 of the latter, so that the pressure sensor only senses the pressure exerted by the belt 231 on the lower surface 224 of the plate 223;
on the lower surface 228 of each applicator 227, which is provided with a connector on the upper surface 230 for permitting the connection of the pressure sensor to the cable 213 connecting to the control panel 209 (or to a wireless device, e.g. located on the plate 223 or handpiece 200, connecting to the control panel 209);
on an area of the belt 231 that is positioned in contact with the user's body segment, the belt 231 being provided with a connection for permitting the connection of the pressure sensor to the cable 213 connecting to the control panel 209 (or to a wireless device, e.g. located on the plate 223 or handpiece 200, connecting to the control panel 209).

The processing device evaluates and displays on the display 210 the curve of the pressure exerted by the applicator 227 on the body area of the user 215 to treat, for allowing the user 215 (and/or a supervising operator) to monitor the correct application of the applicator during treatment, also for diagnostic purposes. In fact, a variation of the pressure exerted by the applicator 227 on the body area of the user 215 to treat substantially modifies the electrical activity of the muscles to which the vibration is transmitted. Therefore, it is important to maintain the pressure exerted by the applicator 227 on the body area of the user 215 to treat as much close as possible to a reference value, so as to correctly carry out the physical exercise and also to correctly evaluate the variations of electromyographic activity detected by possible muscular electrical activity sensors at different frequencies for searching the optimal frequency of vibration, as it will be better described later. By way of example, the processing device may signal (e.g. visually, through the display 210 or specific LEDs, and/or acoustically, through buzzers and/or loudspeakers):
if the pressure exerted by the applicator 227 on the body area of the user 215 to treat is lower than a minimum value, preferably asking for a better fastening of the belt 231 (i.e. a higher pressure) before enabling the operation of the motor 5 if off or automatically interrupting (possibly after a time period of warning) the operation of the motor 5 if already operating;
if the pressure exerted by the applicator 227 on the body area of the user 215 to treat is higher than the minimum value but yet lower than a tolerance value (that is higher than the minimum value), preferably asking for a better fastening of the belt 231 (i.e. a higher pressure) before enabling the operation of the motor 5 (while if the motor 5 is already operating the operation is not interrupted if the pressure does not fall below the minimum value or if within a time period of warning the pressure exceeds the tolerance value).

The pressure sensor allows the pressure exerted by the applicator 227 on the treated muscle/tendon to be measured, permitting, for the duration of the therapy, to maintain constant conditions of neuromuscular mechanical stimulation and to analyse the individual response of a patient consequently adapting the therapy. Moreover, the sensor further enables a possible standardisation of treatments depending on statistical analysis of the data collected with reference to the specifically treated cases.

Other embodiments of the handpiece 200 may be devoid of such pressure sensor 219.

As stated before, the ring nut 222 allows the handpiece 200 to be orientated with respect to the plate 223, and consequently with respect to the applicator 227 coupled to the plate 223. With reference to FIG. 8, it may be observed that the ring nut 222 allows the handpiece 200 to be orientated with respect to the plate 223 according to a specific angle, preferably selected from a set of predetermined angles, more preferably equal to 0°, 20°, 60°, 90°, 120°, 150°, and 180° both clockwise and counterclockwise. Advantageously, as shown in FIG. 9, the upper surface of the plate 223 is provided with indications 234 allowing the user (or a supervising operator) to easily determine the orientation angle of the handpiece 200 with respect to the plate 223 and, consequently, with respect to the applicator 227. The possibility of orienting the coupling between handpiece 200 and plate 223 (and applicator 227) permits to fasten the belt 231 to a body segment as stably as possible, then carrying out the neuromuscular mechanical stimulation according to the orientation most adequate for the area (e.g. a muscle) to treat.

The handpiece 200 is further provided with a system for detecting the movement of the handpiece 200 (or even of the plate 223 and/or of the applicator 227). This system comprises (at least) one vibration sensor (not shown in the Figures), such as a triaxial accelerometer, preferably integrally coupled to an end of the handpiece 200 or incorporated in a corresponding seat internal to the handpiece 200, so as to detect the accelerations along the three Cartesian axes. The triaxial accelerometer sends the detected data, related to one or more movement parameters (such as, for instance, movement amplitude, acceleration and velocity), to the processing device of the control panel 209, that processes the same, e.g., for obtaining the amplitudes related to the oscillations and indirectly defining the degree of contraction and relaxation of the peripheral muscles of the user. Alternatively to or in combination with the triaxial accelerometer, the detection system may comprise further sensors for sensing the movement of the handle 200.

Such system for detecting the movement of the handpiece 200, directly providing for the data related to the movement of the handpiece 200, depending on the neuromuscular reaction of the user's limbs, enables a supervising operator to monitor and characterise the best use of the same handpiece 200. In fact, the movement of the handpiece 200 is strongly affected by the user's capacities of managing the vibrations (e.g. through the stiffness of the limbs, the muscle elasticity, etc.). By way of example and not by way of limitation, in the case where the acceleration detected by the triaxial accelerometer is lower than a maximum threshold, then the use of the handpiece 200 is not harmful for the user, otherwise, i.e. in the case where the detected acceleration is equal to or larger than said maximum threshold, it is necessary to modify, possibly also automatically through the processing device, the frequency at which the vibrating motor 5 operates because the high detected acceleration is an indication of the fact that the user does not absorb vibrations; said maximum threshold of acceleration is preferably a value depending on the amplitude and/or frequency at which the vibrating motor operates, and more preferably it is adjustable depending on the user's state, being higher for an athlete than for an elderly or traumatised subject.

Alternatively to or in combination with the sensors (preferably triaxial accelerometers) for detecting the movement parameters of the handpiece 200 (or even of the plate 223 and/or of the applicator 227), the just described detection system may comprise (at least) one second triaxial accelerometer (or another sensor), indicated in FIG. 2 with the reference number 214, connected through either wireless or wired connection to the processing device, applicable, preferably through an elastic collar or an elastic band (into which it is preferably inserted), to the user 215, preferably in correspondence with a limb interacting with the applicator 227 and/or at the neck base and/or around the waist of the user 215. This (at least one) second triaxial accelerometer 214 is capable to detect one or more parameters of the vibrations (such as, for instance, amplitude, frequency, acceleration and velocity) transmitted to the user 215, permitting a control of the vibrating motor 21 that is either automatic by the processing device or manual by an operator (e.g. a physiotherapist) for preventing the generated vibrations from reaching the soft tissues of the user 215.

Other embodiments of the apparatus according to the invention may be also provided with a system for determining the optimal frequency of vibration and for automatically setting the parameters of operation of the (at least one) vibrating motor 5. In fact, each organ, or body segment, can be described as a body having its own vibration resonance frequency, thus attenuating different vibrating frequencies. In this regard, the exposure of body segments and internal organs to resonance frequencies must be limited, since it may be harmful for some organs. This means that an optimal frequency of activation of the musculature corresponds to each person and to each muscle of the same person.

Preferably, the system for determining the optimal frequency of vibration and for automatically setting the parameters of operation of the (at least one) vibrating motor 5 with which the apparatus according to the invention may be provided is the one disclosed in International Patent No. WO 01/56650. In order to determine whether a muscle undergoing vibration is vibrating at its own optimal frequency of activation, such system may advantageously use one or more electromyography surface sensors, applied on one of the user's muscles interacting with the applicator 227. Such system permits to test a plurality of muscular groups, through a plurality of electromyography channels, to compare them and to define the state of use of the muscular systems under consideration.

In the following, the basic features of the system that is subject matter of the International Patent No. WO 01/56650 applied to the apparatus according to the invention shown in FIGS. 1-3 are briefly recalled.

The motor 5 is driven by a processing and controlling electronic device, preferably housed in the control panel 209 of the handpiece 200 (and possibly coinciding with the processing device of the previously described detection system), that regulates its vibration frequency. In particular, such electronic device is capable to be connected through a cable 216 to one or more muscular electrical activity sensors (preferably electromyography sensors) applicable to the muscles of the user 215, capable to output a digital signal that is read by the electronic device; alternatively, the muscular electrical activity sensors may be connected to the electronic device through a wireless connection. The electronic device processes data coming from said one or more sensors so as to determine, within a range included between a lower limit frequency, preferably equal to 1 Hz, and an upper limit frequency, preferably equal to 1000 Hz, the optimal frequency of vibration of the motor 5 at which the muscle the electrical activity of which is detected has the maximum response to the stimulation and, consequently, setting the frequency of vibration of the same motor. In particular, the lower limit frequency and the upper limit frequency could be variable, depending on the specific fibres of the particular muscle to stimulate, and settable through the control panel 209 of the handpiece 200.

Once said one or more sensors have been applied, in a conventional way, to corresponding user's muscles, the method for determining the optimal frequency preferably comprises the following steps:
repeating for a number N of times, with N preferably equal to eight, a step of data acquisition wherein the electronic device:
   activates the vibration at constant frequency of the motor 5 for a time Δt, with Δt preferably equal to 5 or 10 seconds, with vibration frequency progressively increasing from a repetition to the subsequent one and included between the lower limit frequency and the upper limit frequency,
   computes, for each repetition, the average of the amplitude of the signal coming from each one of said one or more sensors and it individually stores it and/or it stores at least one function (e.g. a possibly weighted sum or average) of the averages coming from all the sensors, along with the value of the corresponding vibration frequency;
determining the maximum electric response, wherein the electronic device determines, among the stored ones, the average (or said at least one function of the averages) having maximum value, consequently determining the optimal frequency of vibration, at which the muscles the electrical activity of which has been detected have the maximum response.

Preferably, the frequencies of consecutive repetitions, during data acquisition, have a constant difference from one another, more preferably equal (for eight repetitions) to 20 Hz, 25 Hz, 30 Hz, 35 Hz, 40 Hz, 45 Hz, 50 Hz, and 55 Hz, respectively. However, it is also possible to have a variable and increasing difference according to a function of the absolute value of the frequency of the preceding repetition.

Once that the optimal frequency has been determined, it is possible to start the step of muscle stimulation, wherein the electronic device activates the vibration of the motor 5 at such optimal frequency for a time span that is predetermined or selectable by the user 215 (or by a supervising operator) through the control panel 209.

Possibly, the step of determining the optimal frequency may be periodically repeated, most of all in the case where the time span of the physical exercise is long.

Alternatively, the method for determining the optimal frequency could determine such frequency by successive approximations, through execution of the following steps:
iterating for a number M of times, with M preferably equal to two, cycles of a number N, of repetitions, where i determines the i-th iteration, of steps of data acquisition wherein the electronic device activates the vibration at constant frequency of the motor 5 for a time Δt, with Δt preferably equal to 10 seconds, with vibration frequency progressively increasing from a repetition to the subsequent one and included between a first lower frequency and a second upper frequency, the frequencies of consecutive repetitions having a constant difference Δf, from one another, where preferably, for the first iteration, the first lower frequency coincides with the lower limit frequency and/or the second upper frequency coincides with the upper limit frequency, the electronic device processing, for each repetition, the average of the amplitude of the signal coming from said one or more sensors and storing it along with the value of the corresponding vibration frequency, the electronic device determining for each iteration i the average having maximum value and determining the corresponding best frequency, in each iteration i, subsequent to the first one, the range between the first lower frequency and the second upper frequency comprising the best frequency as determined in the preceding iteration, preferably as intermediate frequency, in each iteration i, subsequent to the first one, the constant difference Δf, between the frequencies of consecutive repetitions being lower than the difference Δfᵢ₋₁, of the preceding iteration (Δfᵢ<Δfᵢ₋₁);
determining the optimal frequency, at the end of the M-th iteration, wherein the best frequency determined at the M-th iteration is stored as the optimal frequency, at which the muscles the electrical activity of which has been detected have the maximum response.

In other words, the just described method determines the optimal frequency aiming at determining with progressively better resolution the vibration frequency at which the muscles the electrical activity of which has been detected have the maximum response.

Possibly, the values of the optimal frequencies corresponding to various muscles of the same user could be also stored in portable memory media, such as magnetic and/or optical cards or discs, through an interface of the control panel 209, for being readable afterwards by the same interface, avoiding further executions of the method for determining the optimal frequency.

Other embodiments of the apparatus according to the invention may be further conventionally provided with a heart rate monitor.

FIG. 10 schematically shows a second embodiment of the apparatus according to the invention that is different from that shown in FIGS. 1-3, wherein the encoder 218 (or other angular velocity sensor) is integrally coupled to the same end of the handpiece 200 to which the motor 5 is coupled.

Obviously, electrical wiring provided for the apparatus for physical exercise according to the invention must be suitably insulated in order to ensure user's safety, and arranged so as not to hinder the performance of gymnastic exercises.

The preferred embodiments have been described and variations of the present invention have been suggested hereinbefore, but it should be understood that those skilled in the art can make modifications and changes, without so departing from the related scope of protection thereof, as defined by the enclosed claims.

1. An apparatus for transmitting localised vibrations, in particular to muscles of a user, comprising a handpiece, vibrating means being coupled to said at least one handpiece, the apparatus being characterised in that the handpiece is coupled through connecting means to an applicator capable to be applied to an area of the body of the user, said vibrating means being connected to a processing and controlling device that is housed in a control panel and in turn connected to interface means for inputting data capable to set a vibration frequency of said vibrating means.

2. An apparatus according to claim 1, wherein the handpiece is removably coupled to the applicator.

3. An apparatus according to claim 2, wherein said connecting means comprises a plate, to which the handpiece is coupled, provided on a lower surface with one or more, notches in each one of which a respective magnet is present, the applicator having an upper surface provided with one or more projecting elements, made of ferromagnetic material, said one or more projecting elements being capable to insert in said one or more notches, whereby the magnets are capable to attract said one or more projecting elements within said one or more notches.

4. An apparatus according to claim 1, wherein said connecting means comprises a ring nut, integrally coupled to the handpiece or to the applicator, whereby the handpiece is orientatable with respect to the applicator according to an angle.

5. An apparatus according to claim 1, wherein it is provided with at least one pressure sensor capable to detect at least one pressure exerted by the applicator on the area of the body of the user to which it is applied and to send detection data to said processing and controlling device, said interface means comprising one or more visual and/or acoustic signaling devices through which said processing and controlling device signals at least one condition of application of the applicator on the area of the body of the user depending on said at least one pressure detected by said at least one pressure sensor (219), said at least one pressure sensor.

6. An apparatus according to claim 1, provided with belt coupled to the handpiece and fastenable around a body segment of the user in correspondence with the area of the body of the user to which the applicator is applied.

7. An apparatus according to claim 5, further provided with a belt coupled to the handpiece and fastenable around a body segment of the user in correspondence with the area of the body of the user to which the applicator is applied wherein said at least one pressure sensor is located on an area of the belt capable to be positioned in contact with a body segment of the user.

8. An apparatus according to claim 3, further provided with a belt coupled to the handpiece and fastenable around a body segment of the user in correspondence with the area of the body of the user to which the applicator is applied wherein the belt is insertable into at least two slots of the plate, preferably so that the belt is capable to pass under the lower surface of the plate.

9. An apparatus according to claim 5, further provided with a belt coupled to the handpiece and fastenable around a body segment of the user in correspondence with the area of the body of the user to which the applicator is applied, wherein the belt is insertable into at least two slots of the plate, preferably so that the belt is capable to pass under the lower surface of the plate wherein said at least one pressure sensor is arranged on an area of the plate onto which the belt is capable to exert a pressure when it is fastened around a body segment of the user.

10. An apparatus according to claim 1, wherein said at least one handpiece comprises first sensing means capable to detect a frequency of vibration of said at least one handpiece and to send detection data to said processing and controlling device, said processing and controlling device controlling an operation of said vibrating means so that the vibration frequency detected by said first sensing means is equal to a vibration frequency set through said interface means.

11. An apparatus according to claim 1, wherein said vibrating means comprises at least one electric motor, that is housed in a respective seat with which said at least one handpiece is provided, capable to make a shaft arranged along a longitudinal axis of said at least one handpiece rotate, to which shaft one or more eccentric masses are integrally coupled.

12. An apparatus according to claim 10, wherein said vibrating means comprises at least one electric motor, that is housed in a respective seat with which said at least one handpiece is provided, capable to make a shaft arranged along a longitudinal axis of said at least one handpiece rotate, to which shaft one or more eccentric masses are integrally coupled wherein said first sensing means comprises an encoder capable to detect an angular position and/or a rotation speed and/or a rotation frequency of the shaft that said at least one electric motor is capable to rotate.

13. An apparatus according to claim 1, further comprising a detection system comprising movement sensing means capable to detect a movement of said at least one handpiece, said movement sensing means being connected to said processing and controlling device to which it sends detected data related to one or more movement parameters.

14. An apparatus according to claim 1, further comprising vibration sensing means connected to a said processing and controlling device to which it sends detected data related to one or more movement parameters.

15. An apparatus according to claim 1, further comprising a system for determining an optimal frequency of a vibration generated by said vibrating means and for automatically setting parameters of operation of said vibrating means, comprising one or more muscular electrical activity sensors, applicable to one or more muscles of a user, capable to send detection data to said processing and controlling electronic device, said processing and controlling electronic device processing the data received from said one or more sensors so as to determine, within a range included between a lower limit frequency, and an upper limit frequency, preferably equal to 1000 Hz, more preferably variable, an optimal frequency of the vibration generated by said vibrating means at which the electrical activity of said one or more muscles of the user is maximum, said processing and controlling electronic device setting a frequency of the vibration generated by said vibrating means so that it is equal to such optimal frequency.

16. An apparatus according to claim 2, comprising a set of interchangeable applicators attachable to the handpiece.

17. An apparatus according to claim 16, wherein said applicators have a lower surface capable to contact an area of the body of the user and having a shape selected from the group comprising concave shapes, a flat shape, convex shapes, and flat shapes provided with one or more projections.

18. An apparatus according to claim 4, wherein said angle is selected from a set of predetermined angles, both clockwise and counterclockwise.

19. An apparatus according to claim 5, wherein said at least one pressure sensor is located on a lower surface of the applicator capable to contact the area of the body of the user.

20. An apparatus according to claim 19, wherein said processing and controlling device is configured to signal an application condition wherein said at least one detected pressure is lower than at least one minimum value.

21. An apparatus according to claim 20, wherein said processing and controlling device is configured to disable an operation of said vibrating means when said at least one detected pressure is lower than at least one minimum value.

22. An apparatus according to claim 6, wherein the belt is insertable into at least two slots of said connecting means.

23. An apparatus according to claim 9, wherein said at least one pressure sensor is arranged in the lower surface of the plate in a gap between the applicator and the lower surface of the plate.

24. An apparatus according to claim 11, wherein said at least one handpiece comprises a fan capable to cause an air exchange between said seat of said at least one electric motor and the outside of said at least one handpiece.

25. An apparatus according to claim 11, wherein said at least one electric motor is capable to generate an undulating movement at a frequency ranging from 1 to 1000 Hz, or from 5 to 500 Hz, or from 20 to 55 Hz, and of amplitude ranging from 1 to 10 mm, or from 2 to 5 mm.

26. An apparatus according to claim 11, wherein said at least one electric motor is capable to rotate both clockwise and counterclockwise and said interface means for data input is capable to set at least one direction of rotation of said at least one electric motor.

27. An apparatus according to claim 13, wherein said movement sensing means comprises at least one triaxial accelerometer incorporated into or integrally coupled to said at least one handpiece.

28. An apparatus according to claim 13, wherein said one or more movement parameters related to said detected data sent by said sensing movement means to said processing and controlling device are selected from the group comprising movement amplitude, acceleration, and velocity.

29. An apparatus according to claim 13, wherein said processing and controlling device automatically controls said vibrating means on the basis of said data detected by said movement sensing means.

30. An apparatus according to claim 14, wherein said vibration sensing means comprises at least one triaxial accelerometer incorporated into or coupled to at least one support applicable to and/or wearable by a user.

31. An apparatus according to claim 30, wherein said at least one support is selected from the group comprising an elastic collar and an elastic band.

32. An apparatus according to claim 14, wherein said one or more movement parameters related to detected data sent by said vibration sensing means to said processing and controlling device are selected from the group comprising vibration amplitude, frequency, acceleration, and velocity.

33. An apparatus according to claim 14, wherein said processing and controlling device automatically controls said vibrating means on the basis of said data detected by said vibration sensing means.

34. An apparatus according to claim 15, wherein said lower limit frequency is variable and/or said upper limit frequency is variable.
